(19) United States
(12) Patent Application Publication
(10) Pub. No.: US 2024/0326536 A1
(43) Pub. Date: Oct. 3, 2024

(54) DAMPER COUPLER

(71) Applicant: Honda Motor Co., Ltd., Tokyo (JP)

(72) Inventors: Nathan J. ZURBRUGG, West Liberty, OH (US); ERIC J. BOETTCHER, Columbus, OH (US); PHILIP S.H. MOIR, Dublin, OH (US); BRYAN C. SLABACH, West Mansfield, OH (US); JAMISON E. WEIRUP, Marysville, OH (US); AMIT JAIN, Dublin, OH (US); DANIEL A. GROSS, Dublin, OH (US); BHARADWAJ VEERA RAGHAVAN, Powell, OH (US); Alex C. VAN NEST, Columbus, OH (US)

(21) Appl. No.: 18/192,551

(22) Filed: Mar. 29, 2023

(51) Int. Cl. B60G 13/00

(52) U.S. Cl. CPC B60G 13/003

(57) ABSTRACT

A damper coupler is provided. The damper coupler includes a first portion coupled to a first surface of a damper. The damper is removably coupled to a body of a vehicle. The damper coupler further includes a second portion coupled to a first section of the body of the vehicle. The damper coupler further includes a first mid-portion disposed between the first portion and the second portion. The first mid-portion transfers a first load between the first portion and the second portion, to limit a shear force in the damper.

### CROSS-REFERENCE TO RELATED APPLICATIONS/INCORPORATION BY REFERENCE

This application makes reference to U.S. patent application entitled DAMPER COUPLER (Applicant's docket No.; H1223050US02) filed on Mar. 29, 2023.

The above reference application is hereby incorporated herein by reference in its entirety.

### BACKGROUND

Vehicles have dampers to absorb vibrations of the vehicle. For example, dampers may be typically coupled to parts of the vehicles, via damper bolts, to absorb vibrations of the vehicle. In certain instances, few parts of the vehicles may be formed in an angular direction to provide more space for the vehicle. Based on the angular direction of the parts of the vehicle, the dampers may be coupled to such parts, to absorb vibrations of the vehicle. In such instances, the damper bolts of the dampers may experience a shear force along the angular direction, which may potentially loosen the damper bolt.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a damper coupler may be provided. The damper coupler may include a first portion coupled to a first surface of a damper. The damper may be removably coupled to a body of a vehicle. The damper coupler may further include a second portion coupled to a first section of the body of the vehicle. The damper coupler may further include a first mid-portion disposed between the first portion and the second portion. The first mid-portion may be configured to transfer a first load between the first portion and the second portion, to limit a shear force in the damper.

According to another embodiment of the disclosure, a damper coupled may be provided. The damper coupler may include a first portion coupled to a first surface of a damper. The damper may be removably coupled to a body of a vehicle and disposed in a first plane. The damper coupler may further include a second portion that may be coupled to a first section of the body of the vehicle and disposed in a second plane. The second plane may be substantially perpendicular to the first plane. The second portion may be configured to transfer a first load between the vehicle and the damper, via the first portion, to limit a shear force in the damper.

According to another embodiment of the disclosure, a method for forming a damper coupler is disclosed. The method may include forming a first portion coupled to a first surface of a damper. The damper may be removably coupled to a body of a vehicle. The method may further include forming a second portion coupled to a first section of the body of the vehicle. The method may further include forming a first mid-portion disposed between the first portion and the second portion. The first mid-portion may be configured to transfer a first load between the first portion and the second portion, to limit a shear force in the damper.

### BRIEF DESCRIPTION OF THE DRAWINGS

FIG. 1 is a perspective view of a damper coupler for a damper assembled in an exemplary vehicle, in accordance with a first embodiment of the disclosure.

FIG. 2 is a perspective view that illustrates a first exemplary scenario of the damper coupler of FIG. 1, in accordance with an embodiment of the disclosure.

FIG. 3 is a perspective view of a damper coupler for a damper assembled in an exemplary vehicle, in accordance with a second embodiment of the disclosure.

FIG. 4 is a perspective view that illustrates a second exemplary scenario of the damper coupler of FIG. 3, in accordance with an embodiment of the disclosure.

FIG. 5 is a flowchart that illustrates exemplary operations to form the damper coupling of FIG. 1, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed damper coupler. The damper coupler may include a first portion (for example, a first portion of a L-bracket) that may be coupled to a first surface (for example, an external surface) of a damper. The damper may be removably coupled to a body (for example, a body-in-white) of a vehicle. The damper coupler may further include a second portion (for example, a second portion of the L-bracket) that may be coupled to a first section (for example, a A-pillar, D-pillar, etc.) of the body of the vehicle. As the first portion (i.e., the first portion of the L-bracket) is coupled to the damper and the second portion (i.e., the second portion of the L-bracket) is coupled to the body of the vehicle, the damper coupler forms an additional support for the damper, to withstand against any shear force that may loosen the damper from the body of the vehicle.

The damper coupler may further include a first mid-portion disposed between the first portion and the second portion. The first mid-portion may be configured to transfer a first load (for example, an impact load) between the first portion and the second portion, to limit the shear force in the damper. For example, in case of a potential impact load, the mid-portion may act as an interface between the first portion and the second portion and forms a load path that may further provide the additional support for the damper, to withstand against any shear force that may loosen the damper from the body of the vehicle.

Reference will now be made in detail to specific aspects or features, examples of which are illustrated in the accompanying drawings. Wherever possible, corresponding, or similar reference numbers will be used throughout the drawings to refer to the same or corresponding parts.

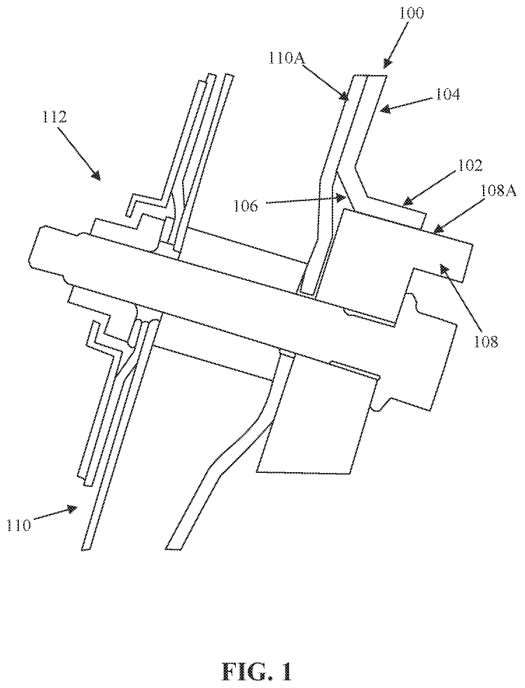

FIG. 1 is a perspective view of a damper coupler for a damper assembled in an exemplary vehicle, in accordance with a first embodiment of the disclosure. With reference to FIG. 1, there is shown a damper coupler 100. The damper coupler 100 may include a first portion 102, a second portion 104, and a first mid-portion 106. The first portion 102 of the damper coupler 100 may be coupled to a first surface 108A of a damper 108. The second portion 104 of the damper coupler 100 may be coupled to a first section 110A of a body 110 of a vehicle 112.

The damper coupler 100 may be a supporting implement that may be configured to support the damper 108 against the body 110 of the vehicle 112. In an embodiment, the damper coupler 100 may be configured to receive shock impulses (such as vibrations) and coverts the received the shock impulses to other forms of energy, such as a linear traction or a heat generation. Examples of the damper coupler 100 may include, but not limited to, a bracket, a pin, a dowel pin, or a surface mounted collar.

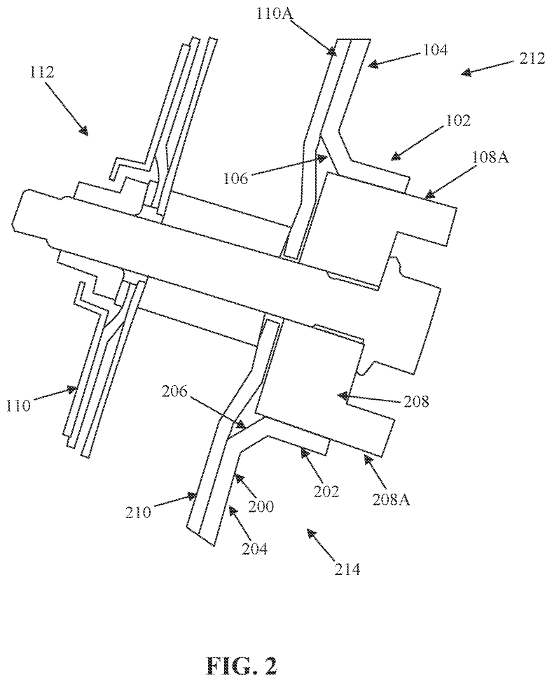

In an embodiment, the damper coupler 100 may be located on the first surface 108A of the damper 108, as shown in FIG. 1. In another embodiment, the damper coupler 100 may be located on an opposite side of the first surface 108A of the damper 108, as shown in FIG. 2. In yet another embodiment, the damper coupler 100 may be located at any part of the damper 108, based on user requirements. For example, in case the damper coupler 100 requires the support on a base of the damper 108, the damper coupler 100 may be disposed on the base of the damper (not shown). In another example, in case the damper coupler 100 requires the support on a top surface of the damper 108, the damper coupler 100 may be disposed on a top of the damper (not shown). Therefore, the damper coupler 100 may be disposed at any location of the damper 108 and at any location of the body 110 of the vehicle, to support the damper 108 against any shear force that may loosen the damper 108 from the body 110 of the vehicle 112.

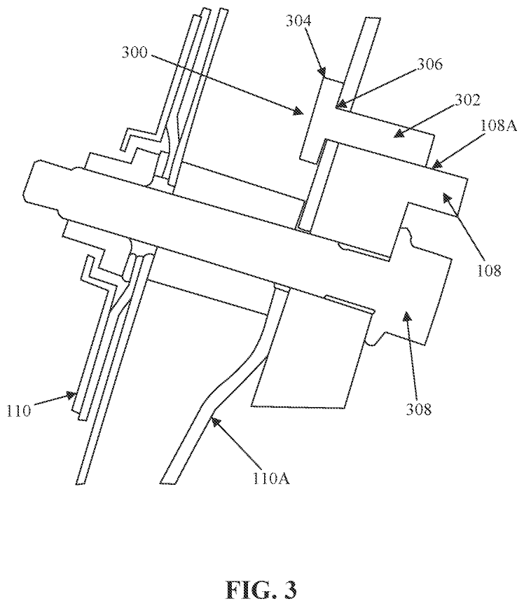

In an embodiment, the first portion 102 and the second portion 104 may form a bracket. For example, the first portion 102 and the second portion 104 may be combined to form a substantially L-shaped profile, such as the bracket a shown in FIG. 1. The L-shaped profile may couple the damper 108 at one end (i.e., the first portion 102), and the body 110 of the vehicle 112 at another end (i.e., the second portion 104), to support the damper 108 against any shear force that may loosen the damper 108 from the body 110 of the vehicle 112. In another embodiment, the first portion 102 and the second portion 104 may form one of: an arcuate bracket or the pin. The damper coupler 100 shown as a single bracket in FIG. 1 is merely an example. The damper coupler 100 may also include one of: a plurality of brackets, a plurality pins, a plurality of dovetail pins, and the like. For example, the first portion 102 and the second portion 104 may be combined to form a substantially pin-shaped profile, such as the pin, as shown in FIG. 3. The pin-shaped profile may include a head portion (not shown) and a stem portion, such that, the head portion is coupled to the body 110 of the vehicle 112 and the stem portion may be coupled to the first surface 108A of the damper 108, to firmly support the damper 108 against any shear force that may loosen the damper 108 from the body 110 of the vehicle 112. Details of the pin-shaped profile of the damper coupler 100 is further described, for example, in FIG. 3.

The first portion 102 may be coupled to the first surface 108A of the damper 108. In an embodiment, the first portion 102 may be coupled to the first surface 108A as a lap joint (for example, a whole of the first portion 102 may be coupled to the first surface 108A). In another embodiment, the first portion 102 may be coupled to the first surface 108A as a butt joint (for example, only a part of the first portion 102 may be coupled to the first surface 108A). In yet another embodiment, the first portion 102 may be coupled to the first surface 108A based on other fastening joint. Such fastening joint may include one of: a screw component, a rivet component, and the like, which may couple the first portion 102 of the damper coupler 100 with the first surface 108A of the damper 108. In certain instances, the first portion 102 may have a first length (not shown) that may be lesser than a length of the second portion 104. In other instances, the first portion 102 may have the first length that may be equal to the length of the second portion 104. In yet other instances, the first portion 102 may have the first length that may be higher than the length of the second portion 104. The length of the first portion 102 and/or the second portion may be modified based on the user requirements and design requirements. For example, in case the first surface 108A of the damper 108 is smaller in length, the first portion 102 may correspondingly have the first length that may match with the length of the first surface 108A of the damper 108.

In an embodiment, the first portion 102 may be formed from a substantially flat structure. For example, the substantially flat structure may have a first shape (such as a rectangular shape) that may conform to a structure of the first surface 108A of the damper 108. The substantially flat structure of the first portion 102 may facilitate a uniform pressure from the first portion 102 towards the first surface 108A of the damper 108. The substantially flat structure may be manufactured via various sheet metal processing techniques, such as, but not limited to, a rolling technique, a bending technique, a blanking technique, a trimming technique, or an embossing technique. Typically, the first portion 102 may be manufactured via the rolling technique (for example, a metallic material is fed between rollers, to form metallic sheets, which may be stamped to form the first portion 102). Further, based on user requirements, the first portion 102 may also be formed as different structures other than the substantially flat structure.

In another embodiment, the first portion 102 may have a substantially arcuate shape. For example, the substantially arcuate shape of the first portion 102 may conform to a shape of the first surface 108A of the damper 108. The substantially arcuate structure of the first portion 102 may facilitate a variable pressure on edges of the first portion 102 compared to a pressure on a mid-section of the first portion 102. Based on the application of pressure, the first portion 102 may be coupled to the first surface 108A of the damper 108. The substantially arcuate structure may be manufactured via various sheet metal processing techniques, such as, but not limited to, a rolling technique, a bending technique, a blanking technique, a trimming technique, or an embossing technique. Typically, the first portion 102 may be manufactured via the bending technique (for example, metallic sheets may be bent via the bending technique to form the first portion 102). Further, based on the user requirements, the first portion 102 may also be formed as different structures other than the substantially arcuate structure. Examples of such structure may include a substantially polygonal structure. Description of such structure is omitted from the disclosure for the sake of brevity. In an embodiment, the first portion 102 may be symmetrical to the second portion 104. In such cases, the second portion 104 and the first portion 102 may be interchangeably deployed as the damper coupler 100 to support the damper 108.

The second portion 104 may be coupled to the first section 110A of the body 110. In an embodiment, the second portion 104 may be coupled to the first section 110A as a lap joint (for example, a whole of the second portion 104 may be coupled to the first section 110A). In another embodiment, the second portion 104 may be coupled to the first section 110A as a butt joint (for example, only a part of the second portion 104 may be coupled to the first section 110A). In yet another embodiment, the second portion 104 may be coupled to the first section 110A based on other fastening joints. Such fastening joints may include one of: a screw component, a rivet component, and the like, which may couple the second portion 104 with the first section 110A of the body 110 of the vehicle.

In an embodiment, the second portion 104 may be formed from a substantially flat structure. For example, the substantially flat structure may have a second shape (such as a rectangular shape) that may conform to a structure of the first section 110A of the body 110 of the vehicle 112. The substantially flat structure of the second portion 104 may facilitate a uniform pressure from the second portion 104 towards the first section 110A of the body 110 of the vehicle 112. The substantially flat structure may be manufactured via various sheet metal processing techniques, such as, but not limited to, a rolling technique, a bending technique, a blanking technique, a trimming technique, or an embossing technique. Typically, the second portion 104 may be manufactured via the rolling technique (for example, a metallic material is fed between rollers, to form metallic sheets, which may be stamped to form the second portion 104). Further, based on user requirements, the second portion 104 may also be formed as different structures other than the substantially flat structure.

In another embodiment, the second portion 104 may have a substantially arcuate shape. For example, the substantially arcuate shape of the second portion 104 may conform to a shape of the first section 110A of the body 110. The substantially arcuate structure of the second portion 104 may facilitate a variable pressure on edges of the second portion 104 compared to a pressure on a mid-section of the second portion 104. Based on the application of pressure, the second portion 104 may be coupled to the first section 110A of the body 110 of the vehicle 112. The substantially arcuate structure may be manufactured via various sheet metal processing techniques, such as, but not limited to, a rolling technique, a bending technique, a blanking technique, a trimming technique, or an embossing technique. Typically, the second portion 104 may be manufactured via the bending technique (for example, metallic sheets may be bent via the bending technique to form the second portion 104). Further, based on the user requirements, the second portion 104 may also be formed as different structures other than the substantially arcuate structure. Examples of such structure may include a substantially polygonal structure. Description of such structure is omitted from the disclosure for the sake of brevity.

The first mid-portion 106 may be disposed between the first portion 102 and the second portion 104. In an embodiment, the first mid-portion 106 may be disposed equidistant from the first portion 102 and/or the second portion 104. In another embodiment, the first mid-portion 106 may be disposed: at a first distance from the first portion 102, and at a second distance from the second portion 104. In certain instances, the first distance may not be same as the second distance. In other instances, the first distance may be lesser than the second distance. Based on the user requirements and the design requirements, the first mid-portion 106 may vary its positional orientation. For example, in case the damper 108 is angularly disposed, the first mid-portion 106 may be disposed at a corner of the damper 108 and aligns the first portion 102 and the second portion 104 against the damper 108 and further mates the first portion 102 of the damper coupler 100 with the first surface 108A of the damper 108.

In an embodiment, the first mid-portion 106 may couple the first portion 102 and the second portion 104, via a chamfered connection (such as an angular connection, for example, about 45 degrees). In another embodiment, the first mid-portion 106 may couple the first portion 102 and the second portion 104, via a filleted connection (such as an arcuate connection, for example, at a specific radius). Based on a type of connection between the first portion 102 and the second portion 104, the first mid-portion 106 may be configured to transfer the first load between the first portion 102 and the second portion 104, such that, the transfer of the first load, may limit the shear force in the damper 108. For example, in case the first mid-portion 106 has the chamfered connection between the first portion 102 and the second portion 104, the first mid-portion 106 may form an angular load path to transfer the first load and limit the shear force in the damper 108. In another example, in case the first mid-portion 106 has the filleted connection between the first portion 102 and the second portion 104, the first mid-portion 106 may form an arcuate load path to transfer the first load and limit the shear force in the damper 108.

In an embodiment, the first portion 102, the second portion 104, and the first mid-portion 106, may be coated with a Zinc Nickel Plating with a yellow-colored passivation, for corrosion resistance of the damper coupler 100. In another embodiment, the first portion 102, the second portion 104, and the first mid-portion 106, may be coated with the Nickel Chromium passivation. Examples of other materials for passivation may include, but are not limited to, Zinc, and Titanium. Based on such passivation coating, the damper coupler 100 may have an additional oxide layer, which may improve a service life of the damper coupler 100.

In certain instances, the first portion 102, the second portion 104, and the first mid-portion 106 may have a thickness ranging from 3 micrometers to 5 micrometers. In other instances, the first portion 102, the second portion 104, and the first mid-portion 106 may have a thickness ranging from 1 micrometer to 50 micrometers. In yet other instances, the first portion 102, the second portion 104, and the first mid-portion 106 may have a thickness that may exceed beyond 50 micrometers. The first portion 102, the second portion 104, and the first mid-portion 106, shown in FIG. 1 is merely an example. It may be understood that the damper coupler 100 may also be configured as only with first portion 102 and the second portion 104, without the first mid-portion 106, and without deviating from the scope of invention.

In an embodiment, the damper 108 may be removably coupled to the body 110 of the vehicle 112. For example, the damper coupler 100 may typically include a mechanical device (such as a cylinder and a piston arrangement) or a hydraulic device (such as a hydraulic cylinder) that may be configured to absorb the shock impulses and dampen the received shock impulses, via at least one of: the linear traction of components (such as the piston) of the damper 108, or transfer the received shock impulses via a suitable load path and dissipate such shock impulses in a form of the heat generation. The damper coupler 100 may also include other components, which may include, a pneumatic device (such as an air cylinder), an electro-magnetic device (such as a solenoid), and the like. Examples of the damper 108 may include, but are not limited to, a mono-tube damper, a twin-tube damper, or a spool valve damper.

The body 110 of the vehicle 112 may be a collection of frames that may be mechanically joined together to form a skeleton (for example, a body-in-white) of the vehicle 112. In certain situations, the collection of frames may be welded to from the body-in-white of the body 110. However, the collection of frames may also be joined based on other mechanical fastening methods, which may include, but are not limited to, a riveting method, a clinching method, a bonding method, or a laser brazing method. In some embodiments, certain parts of the body 110 may be angularly disposed to improve space in a passenger cabin (not shown) of the vehicle 112.

The vehicle 112 may include a non-autonomous vehicle, a semi-autonomous vehicle, or a fully autonomous vehicle, for example, as defined by National Highway Traffic Safety Administration (NHTSA). In some situations, the vehicle 112 may also include a vehicle with autonomous drive capability that uses one or more distinct renewable or non-renewable power sources, such as, a fossil fuel-based vehicle, an electric propulsion-based vehicle, a hydrogen fuel-based vehicle, a solar-powered vehicle, and/or a vehicle powered by other forms of alternative energy sources. The vehicle 112 shown in FIG. 1 is merely an example of a four-wheeled vehicle. In another example, the vehicle 112 may also be a one-wheeler vehicle, a two-wheeler vehicle, or a three-wheeler vehicle. Examples of such vehicles may include, but are not limited to, an electric vehicle, an internal combustion engine (ICE)-based vehicle, or a hybrid vehicle. In yet another example, the vehicle 112 may also include a vehicle with more than four wheels, such as a lorry, truck, and the like.

In operation, the damper coupler 100 is provided. The damper coupler 100 may include the first portion 102 (for example, the first portion of the L-bracket) that may be coupled to the first surface 108A (for example, the external surface) of the damper 108. The damper 108 may be removably coupled to the body 110 of the vehicle 112. The damper coupler 100 may further include the second portion 104 (for example, the second portion of the L-bracket) coupled to the first section 110A (for example, a A-pillar, D-pillar, etc.) of the body 110 of the vehicle 112. As the first portion 102 (i.e., the first portion of the L-bracket) is coupled to the damper 108 and the second portion 104 (i.e., the second portion of the L-bracket) is coupled to the body 110 of the vehicle 112, the damper coupler 100 forms an additional support for the damper 108, to withstand against any shear force that may loosen the damper 108 from the body 110 of the vehicle 112.

The damper coupler 100 may further include the first mid-portion 106 disposed between the first portion 102 and the second portion 104. Based on reception of vibrations from the body 110 of the vehicle 112, the first mid-portion 106 forms a load path (such as the angular load path or the arcuate load path based on the structure of the first mid-portion 106) to transfer the first load between the first portion 102 and the second portion 104 and limits the shear force in the damper 108.

In an alternate embodiment, the damper coupler 100 may include the first portion 102 that may be coupled to the first surface 108A of the damper 108. The damper 108 may be removably coupled to the body 110 of the vehicle 112 and disposed in a first plane. The damper coupler 100 may further include the second portion 104 that may be coupled to the first section 110A of the body 110 of the vehicle 112. The second portion 104 may be disposed in a second plane. The second plane may be substantially perpendicular to the first plane. Therefore, the second portion 104 may be located in a position that may be substantially perpendicular to the first portion 102 of the damper coupler 100. Based on the reception of vibrations from the body 110 of the vehicle 112, the second portion 104 may be configured to transfer the first load between the vehicle 112 and the damper 108, via the first portion 102, to limit the shear force in the damper 108. For example, the damper coupler 100 forms a load path form the body 110 of the vehicle 112 to the second portion 104, via the first portion 102, to limit the shear force in the damper 108. In such embodiment, the damper coupler 100 has a minimalistic structure without any mid-portion between the first portion 102 and the second portion 104, which eventually minimizes a manufacturing cost of the damper coupler 100.

FIG. 2 is a perspective view that illustrates a first exemplary scenario of the damper coupler of FIG. 1, in accordance with an embodiment of the disclosure. FIG. 2 is explained in conjunction with elements from FIG. 1. With reference to FIG. 2, there is shown a damper coupler 200 that may have a third portion 202, a fourth portion 204, and a second mid-portion 206. The third portion 202 of the damper coupler 200 may be configured to couple with a second surface 208A of a damper 208. The fourth portion 204 of the damper coupler 200 may be configured to couple with a second section 210 of the body 110 of the vehicle 112.

The damper coupler 200 and its corresponding elements, such as the third portion 202, the fourth portion 204, and the second mid-portion 206 may be substantially same as the damper coupler 100 and its corresponding elements, such as the first portion 102, the second portion 104, and the first mid-portion 106, as described in FIG. 1. Hence, description of the damper coupler 200 and its corresponding elements are omitted from the disclosure for the sake of brevity. Further, the damper 208 may be substantially same as the damper 108, and it may be understood that the damper 108 is a cut-out section of the damper 208, as described in FIG. 1. Hence, description of the damper 208 is omitted from the disclosure for the sake of brevity.

In an embodiment, the first portion 102 and the second portion 104 may form a first bracket 212. Similarly, the third portion 202 and the fourth portion 204 may form a second bracket 214. In an embodiment, each of the first bracket 212 and the second bracket 214 may be fixedly coupled to the damper 208, to form an annular structure. In such instances, the damper coupler 200 and the damper coupler 100 are integrally connected to form the annular structure. For example, the annular structure may be formed based on a metal forming process. The metal forming process may include, but not limited to, an extrusion technique, the rolling technique, the bending technique, the blanking technique, the trimming technique, or the embossing technique. Description of the metal forming process has been omitted from the disclosure for the sake of brevity.

In an alternate embodiment, the first portion 102 and the second portion 104 may form the first bracket 212. Similarly, the third portion 202 and the fourth portion 204 may form the second bracket 214. In an embodiment, the first bracket 212 may be fixedly coupled to the damper 208 and the second bracket 214 may be adjustably coupled to the damper 208. Therefore, the damper coupler 200 and the damper coupler 100 may be separate components and not an integrated annular structure. In such instances, the damper coupler 200 and the damper coupler 100, may have multiple degrees of freedom to couple with the damper 208 and limit the shear force in the damper 208. It may be noted that when the damper coupler 200 and the damper coupler 100 are provided as the separate components, it may be easier for the operator to install the damper couplers to the damper 208 and assemble them, instead of assembling the integrated annular structure with an interference fit against the damper 208.

The damper coupler 200 may include the third portion 202 coupled to a second surface 208A of the damper 208. The second surface 208A of the damper 208 may be located substantially opposite to the first surface 108A of the damper 108 shown in FIG. 1. In an embodiment, the first portion 102 may be symmetrical to the third portion 202. Therefore, the third portion 202 of the damper coupler 200 may provide additional support in addition to the first portion 102 of the damper coupler 100, and further limit the shear stress in the damper 208.

The damper coupler 200 may further include the fourth portion 204 coupled to a second section 210 of the body 110 of the vehicle 112. The second section 210 may be different from the first section 110A of the body 110 of the vehicle 112. For example, the first section 110A may be located at one side (for example, a left side) of the body 110 and the second section 210 may be located at other side (for example, a right side) of the body 110. In an embodiment, the second portion 104 may be symmetrical to the fourth portion 204. Therefore, the fourth portion 204 of the damper coupler 200 may provide additional support in addition to the second portion 104 of the damper coupler 100, and further limit the shear stress in the damper 208.

The damper coupler 200 may further include the second mid-portion 206 disposed between the third portion 202 and the fourth portion 204. The second mid-portion 206 may be configured to transfer the second load between the third portion 202 and the fourth portion 204, to limit the shear force in the damper 208. Therefore, the second mid-portion 206 of the damper coupler 200 may provide additional support in addition to the first mid-portion 106 of the damper coupler 100, and further limit the shear stress in the damper 208.

In operation, the second mid-portion 206 and the first mid-portion 106 may receive the first load and the second load from the body 110 of the vehicle 112 and forms a twin load path to transfer such load from the second portion 104 and the fourth portion 204 towards the first portion 102 and the third portion 202, via the first mid-portion 106 and the second mid-portion 206 respectively, to limit the shear stress in the damper 208. For example, the first mid-portion 106 forms the first load path between the first portion 102 and the second portion 104, and simultaneously the second mid-portion 206 forms the second load path between the third portion 202 and the fourth portion 204, to limit the shear stress twice and improve a service life of the damper 208.

FIG. 3 is a perspective view of a damper coupler for a damper assembled in an exemplary vehicle, in accordance with a second embodiment of the disclosure. FIG. 3 is explained in conjunction with elements from FIG. 1 and FIG. 2. With reference to FIG. 3, there is shown a damper coupler 300. The damper coupler 300 may include a first portion 302, a second portion 304, and a first mid-portion 306. The damper coupler 300 is configured to limit shear stress in the damper 108 and secure a damper bolt 308 associated with the damper 108.

The damper coupler 300 and its corresponding elements, such as the first portion 302, the second portion 304, and the first mid-portion 306 may be substantially same as the damper coupler 100 and its corresponding elements, such as the first portion 102, the second portion 104, and the first mid-portion 106, as described in FIG. 1. Hence, description of the damper coupler 200 and its corresponding elements are omitted from the disclosure for the sake of brevity.

In an embodiment, the first portion 302 and the second portion 304 may form one of: an arcuate bracket or a pin. In such situations, the first portion 302 may be disposed below the first section 110A of the body 110, and the second portion 304 may be disposed above the first section 110A of the body 110. Such structural arrangement may further limit the shear force that may formed on the damper 108, as compared to the limitation of the shear force, via the first bracket 212, as shown in FIG. 2.

In an embodiment, the first portion 302 and the second portion 304 form the pin, which may have a head section and a shaft section. The shaft section may be integrated with the head section. The head section may be disposed above the first section 110A of the body 110, and the shaft section may be disposed through and below the first section 110A of the body 110. The shaft section may be configured to secure the damper 108 against any horizontal vibrations of the body 110 and the head section may be configured to secure the damper 108 against any vertical vibrations of the body 110. Therefore, such configuration may further limit the shear force of the damper 108, which may be formed in both vertical and horizontal directions of the body 110 of the vehicle 112.

The damper bolt 308 may be a type of mechanical fastener that may be configured to secure the damper 108 on to the body 110 of the vehicle 112. The damper bolt 308 may include a plurality of male threads that may be configured to mate with a plurality of female threads on the damper 108 and the body 110 of the vehicle 112, to secure the damper 108 against the body 110 of the vehicle 112. The damper bolt 308 may be typically assembled along with a damper nut, which may be configured to secure the damper on other side of the body 110 of the vehicle 112. Examples of the damper bolt 308 may include, an arbor bolt, a carriage bolt, a hex bolt, a J-bolt, a lag bolt, a U-bolt, and the like.

In operation, each of the first portion 302, the second portion 304 and the first mid-portion 306 is configured to be installed prior to an insertion of the damper bolt 308 in the damper 108. During insertion of the damper bolt 308, at least one of: the first portion 302, the second portion 304, or the first mid-portion 306 may guide the insertion of the damper bolt 308 in the damper 108. For example, when an operator assembles the damper 108 on the body 110 of the vehicle 112, due to intricate locations (such as locations near a wheel rim of the vehicle 112) of the body 110, it may be difficult to insert the damper bolt 308 in the damper 108 and assembling the damper 108 against the body 110 of the vehicle 112. In such situations, the operator may directly assemble the damper coupler 300 prior to insertion of the damper bolt 308. Based on the assembly of the damper coupler 300, the operator may insert the damper bolt 308 at ease.

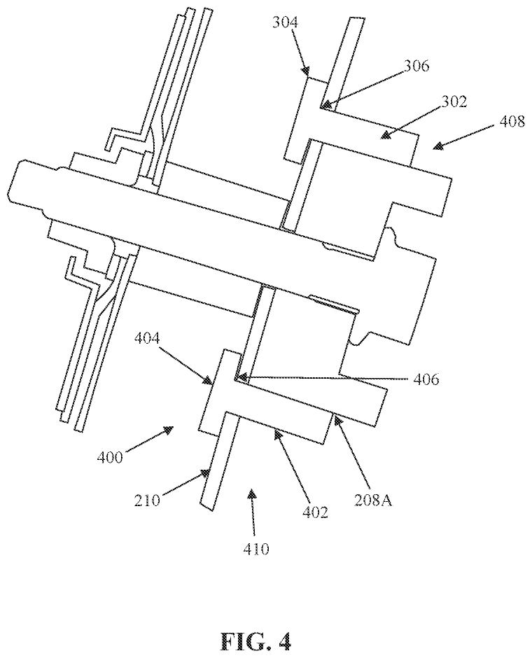

FIG. 4 is a perspective view that illustrates a second exemplary scenario of the damper coupler of FIG. 3, in accordance with an embodiment of the disclosure. FIG. 4 is explained in conjunction with elements from FIG. 1, FIG. 2, and FIG. 3. With reference to FIG. 4, there is shown a damper coupler 400. The damper coupler 400 may include a third portion 402, a fourth portion 404, and a second mid-portion 406. The third portion 402 of the damper coupler 400 may be configured to couple with a second surface 208A of the damper 208 (shown in FIG. 2). The fourth portion 404 of the damper coupler 400 may be configured to couple with a second section 210 of the body 110 of the vehicle 112.

The damper coupler 400 and its corresponding elements, such as the third portion 402, the fourth portion 404, and the second mid-portion 406 may be substantially same as the damper coupler 300 and its corresponding elements, such as the first portion 302, the second portion 304, and the first mid-portion 306, as described in FIG. 3. Hence, description of the damper coupler 400 and its corresponding elements are omitted from the disclosure for the sake of brevity. Further, the damper 208 may be substantially same as the damper 108, and it may be understood that the damper 108 is a cut-out section of the damper 208, as described in FIG. 1. Hence, description of the damper 208 is omitted from the disclosure for the sake of brevity.

In an embodiment, the first portion 302 and the second portion 304 may form a first pin 408. Similarly, the third portion 402 and the fourth portion 404 may form a second pin 410. In an embodiment, each of the first pin 408 and the second pin 410 may be fixedly coupled to the damper 208, to form an annular structure. In such instances, the damper coupler 400 and the damper coupler 300 are integrally connected to form the annular structure. For example, the annular structure may be formed based on a metal forming process. The metal forming process may include, but not limited to, an extrusion technique, the rolling technique, the bending technique, the blanking technique, the trimming technique, or the embossing technique. Description of the metal forming process has been omitted from the disclosure for the sake of brevity.

In an alternate embodiment, the first portion 302 and the second portion 304 may form the first pin 408. Similarly, the third portion 402 and the fourth portion 404 may form the second pin 410. In an embodiment, the first pin 408 may be fixedly coupled to the damper 108 (shown in FIG. 3) and the second pin 410 may be adjustably coupled to the damper 208 (shown in FIG. 2). Therefore, the damper coupler 400 and the damper coupler 300 may be separate components and not an integrated annular structure. In such instances, the damper coupler 200 and the damper coupler 100, may have multiple degrees of freedom to couple with the damper 208 and limit the shear force in the damper 208. It may be noted that when the damper coupler 400 and the damper coupler 300 are provided as the separate components, it may be easier for the operator to install the damper couplers to the damper 208 and assemble them, instead of assembling the integrated annular structure with an interference fit against the damper 208.

The damper coupler 400 may include the third portion 402 coupled to a second surface 208A of the damper 208. In an embodiment, the first portion 302 may be symmetrical to the third portion 402. Therefore, the third portion 402 of the damper coupler 400 may provide additional support in addition to the first portion 302 of the damper coupler 300, and further limit the shear stress in the damper 208.

The damper coupler 400 may further include the fourth portion 404 coupled to a second section 210 of the body 110 of the vehicle 112. In an embodiment, the second portion 304 may be symmetrical to the fourth portion 404. Therefore, the fourth portion 404 of the damper coupler 400 may provide additional support in addition to the second portion 304 of the damper coupler 300, and further limit the shear stress in the damper 208.

The damper coupler 400 may further include the second mid-portion 406 disposed between the third portion 402 and the fourth portion 404. The second mid-portion 406 may be configured to transfer the second load between the third portion 402 and the fourth portion 404, to limit the shear force in the damper 208. Therefore, the second mid-portion 406 of the damper coupler 400 may provide additional support in addition to the first mid-portion 306 of the damper coupler 300, and further limit the shear stress in the damper 208.

In operation, the second mid-portion 406 and the first mid-portion 306 may receive the first load and the second load from the body 110 of the vehicle 112 and forms a twin load path to transfer such load from the second portion 304 and the fourth portion 404 towards the first portion 302 and the third portion 402, via the first mid-portion 306 and the second mid-portion 406 respectively, to limit the shear stress in the damper 208. For example, the first mid-portion 306 forms the first load path between the first portion 302 and the second portion 304, and simultaneously the second mid-portion 406 forms the second load path between the third portion 402 and the fourth portion 404, to limit the shear stress twice and improve a service life of the damper 208.

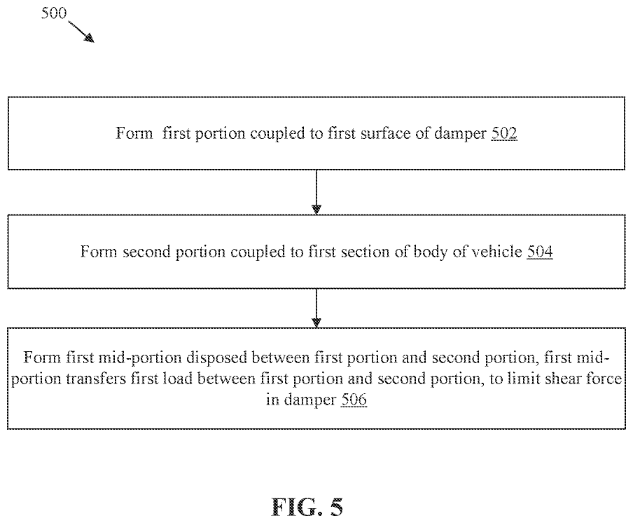

FIG. 5 is a flowchart that illustrates exemplary operations to form the damper coupling of FIG. 1, in accordance with an embodiment of the disclosure. FIG. 5 is explained in conjunction with elements from FIG. 1, FIG. 2, FIG. 3, and FIG. 4. With reference to FIG. 5, there is shown a flowchart 500. The operations from 502 to 508 may be implemented, for example, by a user or a manufacturer of the vehicle 112. The operations of the flowchart 500 may start at 502.

At 502, the first portion 102 may be formed. In an embodiment, an user or a manufacturer of the vehicle 112 may form the first portion 102 that may be coupled to the first surface 108A of the damper 108, as described further, for example, FIG. 1.

At 504, the second portion 104 may be formed. In an embodiment, the user or the manufacturer may form the second portion 104 that may be coupled to the first section 110A of the body 110 of the vehicle 112 as described, for example, in FIG. 1.

At 506, the first mid-portion 106 may be disposed between the first portion 102 and the second portion 104. In an embodiment, the user or the manufacturer may form the first mid-portion 106 that may be disposed between the first portion 102 and the second portion 104. The first mid-portion 106 may transfer the first load between the first portion 102 and the second portion 104, to limit the shear force in the damper 108 as described, for example, in FIG. 1.

The flow chart shown in FIG. 5 is illustrated as discrete operations, such as from 502 to 506, which relates to the formation of the damper coupler 100 for the vehicle 112. However, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”. “comprising”, “incorporating”, “consisting of”, “have”, “is” used to describe, and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A damper coupler, comprising:
a first portion coupled to a first surface of a damper, wherein the damper is removably coupled to a body of a vehicle;
a second portion coupled to a first section of the body of the vehicle; and
a first mid-portion disposed between the first portion and the second portion, wherein
the first mid-portion is configured to transfer a first load between the first portion and the second portion, to limit a shear force in the damper.

2. The damper coupler according to claim 1, wherein the first portion is formed from a substantially flat structure, and wherein the substantially flat structure has a first shape that conforms to a structure of the first surface of the damper.

3. The damper coupler according to claim 1, wherein the second portion is formed from a substantially flat structure, and wherein the substantially flat structure has a second shape that conforms to a structure of the first section of the body.

4. The damper coupler according to claim 1, wherein the first portion and the second portion form a bracket.

5. The damper coupler according to claim 1, wherein the first portion has a substantially arcuate shape, and wherein the substantially arcuate shape of the first portion conforms to a shape of the first surface of the damper.

6. The damper coupler according to claim 1, wherein the second portion has a substantially arcuate shape, and wherein the substantially arcuate shape of the second portion conforms to a shape of the first section of the body.

7. The damper coupler according to claim 1, wherein the first portion and the second portion form one of: an arcuate bracket or a pin.

8. The damper coupler according to claim 1, further comprising:
a third portion coupled to a second surface of the damper, wherein the second surface is substantially opposite to the first surface of the damper;
a fourth portion coupled to a second section of the body of the vehicle, wherein the second section is different from the first section of the body of the vehicle; and
a second mid-portion disposed between the third portion and the fourth portion, wherein
the second mid-portion is configured to transfer a second load between the third portion and the fourth portion, to limit the shear force in the damper.

9. The damper coupler according to claim 8, wherein
the first portion and the second portion form a first bracket; and
the third portion and the fourth portion form a second bracket, wherein the first bracket is fixedly coupled to the damper and the second bracket is adjustably coupled to the damper.

10. The damper coupler according to claim 8, wherein
the first portion and the second portion form a first bracket; and
the third portion and the fourth portion form a second bracket, wherein each of the first bracket and the second bracket is fixedly coupled to the damper, to form an annular structure.

11. The damper coupler according to claim 10, wherein
the annular structure is formed based on a metal forming process.

12. The damper coupler according to claim 8, wherein
the first portion and the second portion form a first pin; and
the third portion and the fourth portion form a second pin, wherein the first pin is fixedly coupled to the damper and the second pin is adjustably coupled to the damper.

13. The damper coupler according to claim 8, wherein
the first portion and the second portion form a first pin; and
the third portion and the fourth portion form a second pin, wherein each of the first pin and the second pin is fixedly coupled to the damper, to form an annular structure.

14. The damper coupler according to claim 8, wherein
the first portion is symmetrical to the third portion; and
the second portion is symmetrical to the fourth portion.

15. The damper coupler according to claim 1, wherein
the first portion is symmetrical to the second portion.

16. The damper coupler according to claim 1, wherein
the first portion, the first mid-portion, and the second portion are coated with a Zinc Nickel Plating with a yellow-colored passivation, for corrosion resistance of the damper coupler.

17. The damper coupler according to claim 1, wherein
the first portion, the first mid-portion, and the second portion has a thickness ranging from 3 micrometers to 5 micrometers.

18. The damper coupler according to claim 1, wherein
each of the first portion, the first mid-portion, and the second portion is configured to be installed prior to an insertion of a damper bolt in the damper, and wherein one of: the first portion, the first mid-portion, or the second portion, guides the insertion of the damper bolt in the damper.

19. A damper coupler, comprising:
a first portion coupled to a first surface of a damper, wherein the damper is removably coupled to a body of a vehicle and disposed in a first plane; and
a second portion coupled to a first section of the body of the vehicle, wherein the second portion is disposed in a second plane, wherein the second plane is substantially perpendicular to the first plane, wherein
the second portion is configured to transfer a first load between the vehicle and the damper, via the first portion, to limit a shear force in the damper.

20. A method, comprising:
forming a first portion coupled to a first surface of a damper, wherein the damper is removably coupled to a body of a vehicle;
forming a second portion coupled to a first section of the body of the vehicle; and
forming a first mid-portion disposed between the first portion and the second portion, wherein
the first mid-portion is configured to transfer a first load between the first portion and the second portion, to limit a shear force in the damper.
